(19) United States
(12) Patent Application Publication
(10) Pub. No.: US 2022/0387876 A1
(43) Pub. Date: Dec. 8, 2022

(54) SPORTING GOODS IDENTIFICATION BAND

(71) Applicant: Juan Pablo Benito Maestas, III, Santa Maria, CA (US)

(72) Inventor: Juan Pablo Benito Maestas, III, Santa Maria, CA (US)

(21) Appl. No.: 17/303,615

(22) Filed: Jun. 3, 2021

(51) Int. Cl. A63B 71/14; A41D 19/00

(52) U.S. Cl. CPC A63B 71/143; A41D 19/0051; A63B 2209/10; A63B 2102/18

(57) ABSTRACT

An apparatus and method to apply an identification marking patch to the wrist strap of a baseball glove. The invention described here allows for temporary identification and marking on baseball gloves by a removable applicator band that connects to the glove. This results in countless customization options that does not permanently mark a player's name or design on the glove. Aside from changing markings, the user can also remove the applicator entirely, thus bringing the glove back to its original state without compromising the leather.

### BACKGROUND OF THE INVENTION

The present invention relates to baseball gloves, and more particularly to apparatus and methods of marking or identify a glove.

Baseball gloves are difficult to identify, particularly when they are bunched with a number of other gloves. There are only a few design and color combinations making it difficult for kids to select the right glove from a pile.

Marking your baseball glove with a permanent marker is inefficient and meant you were unable to make a mistake in spelling and once permanently marked the glove was bound to being identified only to you. It limits the resale value of a glove and prevents the conditioning of the leather to be effective in the marked area. Secondly, the only other way to label your glove was to burn or engrave your name. This meant an individual skilled in leather working would have to apply your name or design onto your leather. Any amateur in this process could risk permanently disfiguring and potentially rendering your glove unusable.

As can be seen, there is a need for an improved apparatus and method that allows for temporary identification and marking on gloves by being a removable applicator that connects to the glove.

### SUMMARY OF THE INVENTION

In one aspect of the present invention, an apparatus for identifying a sporting equipment glove is disclosed. The sporting equipment glove has a wristband for retaining the sporting equipment glove on an athlete's hand. The apparatus includes an elongate strap having a first end, a second end, a back face, and an inner face. The elongate strap has a length corresponding to the length of the wristband and a width approximately twice a width of the wristband. An attachment point is provided on the back face of the elongate strap at an intermediate portion thereof. The attachment point is configured to removably receive a patch carrying one or more identifying indicia selected by the athlete. A first end tab is disposed at the first end of the strap and a second end tab is disposed at the second end of the strap. The first end tab and the second end tab are configured to be cooperatively joined in an overlapping manner about the wristband.

In some embodiments, a first hook and pile pad is attached to an inner face of the first end tab. A cooperating second hook and pile pad is attached to the back face of the second end tab.

In some embodiments, the attachment point also includes a hook and pile material configured for cooperative engagement with a corresponding hook and pile material attached to an inner face of the patch.

In some embodiments, the elongate strap is formed of a washable fabric material.

In other embodiments, a patch having a first surface carrying the one or more identifying and a second surface having the cooperating hook and pile fastener is placed in attachment with the attachment point.

In other aspects of the invention, an apparatus for identifying a sporting equipment item is disclosed. The sporting equipment item having a wristband for retaining the sporting equipment glove on an athlete's hand. The apparatus includes a patch applicator band formed as an elongate strap having a first end, a second end, an inner surface, and a back surface. A first end tab is disposed at the first end of the strap. A second end tab is disposed at the second end of the strap. The first end tab and the second end tab are cooperatively joined in an overlapping manner about a width of the wristband.

In some embodiments, a first hook and pile pad is attached to an inner surface of the first end tab and a cooperating second hook and pile pad attached to the back surface of the second end tab.

In some embodiments, an attachment point is coupled to the back surface of the patch applicator band. The attachment point includes a first hook and pile material.

In other embodiments, a patch having an outer surface carrying one or more identifying indicia and an inner surface having a cooperating second hook and pile material is removably attached to the attachment point.

In yet other embodiments, a length of the elongate strap corresponds to a length of the wristband. A width of the elongate strap may be about twice a width of the wristband.

These and other features, aspects and advantages of the present invention will become better understood with reference to the following drawings, description and claims.

### BRIEF DESCRIPTION OF THE DRAWINGS

FIG. 1 is a top plan view of a baseball glove with an identification band according to aspects of the present invention.

FIG. 2 is a top plan view of an identification band shown laid out in an extended flat condition.

FIG. 3 is a perspective view of an identification band showing a first fold.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention.

Broadly, embodiments of the present invention provide a system, method, and apparatus for providing a temporary identification marker to a baseball glove. As stated above, baseball gloves are difficult to identify. There are only a few design and color combinations making it difficult for kids to select the right glove from a pile.

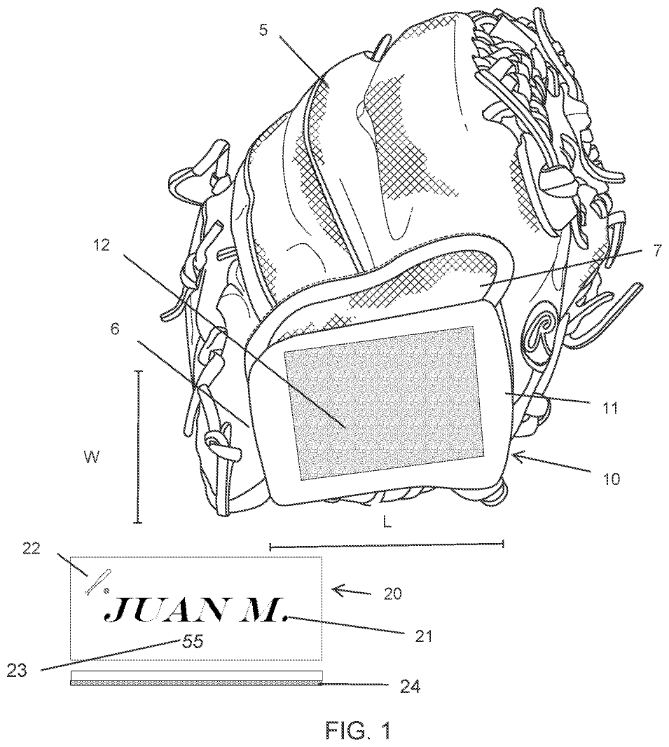

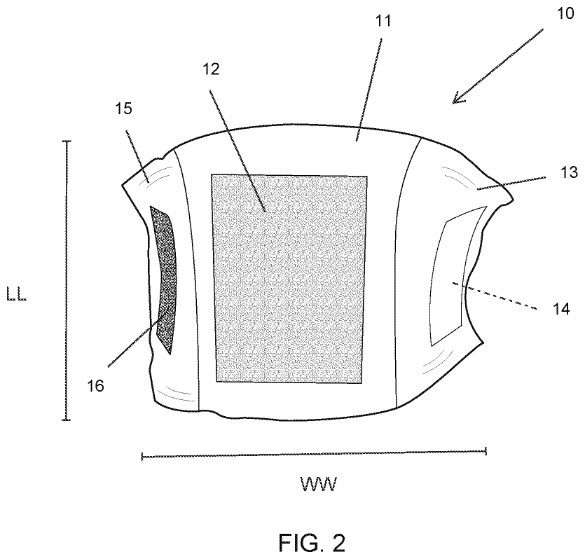

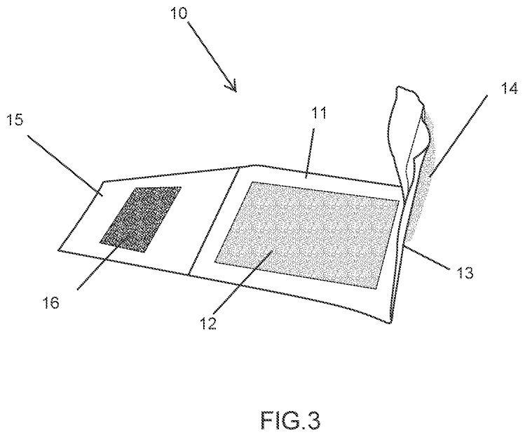

As seen in reference to the drawings of FIGS. 1-3, a patch applicator band 10 of the invention attaches to a wrist strap 6 of a baseball glove 5, allowing the owner to select a unique patch 20 and custom patches with identifying indicia 21-23 such as names 21, numbers 23, logos 22, and the like, to be placed in a clearly visible location on the patch 20. A reverse side of the patch 20 has a layer of a hook and a pile material 24 for engagement with a cooperating layer of a hook and a pile material 12 disposed on a back side 11 of the patch applicator band 10.

Prior to this invention, the only way to identify a user's baseball glove 5 was to use a marker or pen for inscribing your name or burn the leather, each of which permanently damages and compromises the integrity of the leather. Marking the glove 5 with a permanent marker or leather burner is labor intensive, compromises the leather, and irreversible. It could lead to costly repairs if done incorrectly and reduce the longevity of the glove 5.

The present invention allows for effortless, immediate, and reversible labeling of a baseball glove 5. The invention described here allows for temporary identification and marking on gloves 5 by providing a removable band 10 that connects to the wristband 6 the glove 5.

As indicated, a back side 11 of the patch applicator band 10 provides an attachment point 12 for a card 20, or placard, carrying identification indicia 21-23 selected by the user to identify the user's glove 5. This results in countless customization options that do not permanently mark a player's name or design on the glove 5. Aside from changing markings, one can also remove the patch applicator band 10 entirely, thus bringing the glove 5 back to its original state without compromising the leather. In a smaller embodiment, it can produce Hook and loop applicators on the outside of batting gloves, the chest protector of the catcher's gear, batting elbow guards and other protective equipment and sports accessories.

Embodiments of the invention may include: a patch applicator band 10, preferably formed of a textile washable fabric. The patch applicator band 10 has a length LL corresponding to a length L of the strap 6 of the baseball glove 5. The patch applicator band 10 has a width WW that is roughly twice a width W of the strap 6 of the baseball glove 5.

A first end tab 13 of the patch applicator band 10 has a first hook and pile pad 14 attached to an inner face of the first end tab 13. A second end tab 15 has a cooperating second hook and pile pad 16 attached to the back side of the second end tab 15. The first hook and pile pad 14 and the cooperating second hook and pile pad 16 are configured to be fastened when the first end tab 13 and the second end tab 15 are wrapped about a width W of the strap 6 of the baseball glove 5. The patch applicator band 10 is positioned on the wrist strap 6 of the baseball glove 5 such that the attachment point 12 is exposed to an outer face of the wrist strap 6.

The patch applicator band 10 is first cut to a dimension to fit and wrap around the wrist strap 6 such that the first end tab 13 and the second end tab 15 are disposed in an overlapping manner. The cooperating fasteners 14, 16 are then attached to the patch applicator band 10 on opposite sides of the respective first end tab 13 and second end tab 15. The first hook and pile tab 14 (Velcro®) applicator is then applied to the fabric in the outermost facing location as to be easily identified. Once fastened to the baseball glove any person may apply any cooperating hook and loop (Velcro®) based marking or patch 20 via the cooperating hook and pile fastener 24 to the attachment point 12 in order to uniquely identify their baseball glove 5. Once the glove 5 changes ownership or the individual progresses to another team, or level, and wants to identify or represent something different they simply remove the marking or patch 20 from the attachment point 12.

If the baseball glove is in need of a cleaning one would simply un-fasten the cooperating fasteners 2 and remove the attachment band 1 leaving the glove in its original condition undamaged.

Once the textile fabric are procured, they must be measured, cut to the design template then woven together at regular intervals to allow for an even blend of stitching. One could accomplish this cutting process oneself given an appropriate cutting apparatus and one could accomplish this weaving process oneself given an appropriate sewing apparatus, or one could outsource the weaving process to a commercial or specialized enterprise alongside the cutting process. The resulting textile would then need to have the fastener woven onto the appropriate points to secure the textile to the baseball glove. This could be accomplished in the outline weaving process stated above. Lastly the hook and loop (Velcro®) applicator would be woven onto the resulting textile in its desired location for the application of marking and patches for identification. This can also be accomplished via the weaving process stated above.

As will be appreciated from the present disclosure, one could interchange the hook and loop applicator with an adhesive backing to allow for different patches or stickers to be applied. One could also interchange the fasteners with buttons or snap fasteners. One could also interchange the textile fabric to a leather based textile.

It should be understood, of course, that the foregoing relates to exemplary embodiments of the invention and that modifications may be made without departing from the spirit and scope of the invention as set forth in the following claims.

What is claimed is:

1. A apparatus for identifying a sporting equipment glove, the sporting equipment glove having a wristband for retaining the sporting equipment glove on a hand of an athlete, comprising:
an elongate strap having a first end, a second end, a back face, and an inner face; the elongate strap having a length corresponding to the length of the wristband and a width approximately twice a width of the wristband;
an attachment point provided on the back face of the elongate strap at an intermediate portion thereof, the attachment point configured to removably receive a patch carrying one or more identifying indicia selected by the athlete;
a first end tab disposed at the first end of the elongate strap; and
a second end tab disposed at the second end of the elongate strap, wherein the first end tab and the second end tab are configured to be cooperatively joined in an overlapping manner about the wristband.

2. The apparatus of claim 1, further comprising:
a first hook and pile pad attached to an inner face of the first end tab; and
a cooperating second hook and pile pad attached to the back face of the second end tab.

3. The apparatus of claim 2, wherein the attachment point further comprises a hook and pile material configured for cooperative engagement with a corresponding hook and pile material attached to an inner face of the patch.

4. The apparatus of claim 3, wherein the elongate strap is formed of a washable fabric material.

5. The apparatus of claim 4, further comprising:
a patch having a first surface carrying the one or more identifying and a second surface having a cooperating hook and pile fastener in attachment with the attachment point.

6. An apparatus for identifying a sporting equipment glove, the sporting equipment glove having a wristband for retaining the sporting equipment glove on an athlete's hand, comprising:
a patch applicator band formed as an elongate strap having a first end, a second end, an inner surface, and a back surface;
a first end tab disposed at the first end of the elongate strap; and
a second end tab disposed at the second end of the elongate strap, wherein the first end tab and the second end tab are cooperatively joined in an overlapping manner about a width of the wristband.

7. The apparatus of claim 6, further comprising:
a first hook and pile pad attached to an inner surface of the first end tab; and
a cooperating second hook and pile pad attached to the back surface of the second end tab.

8. The apparatus of claim 7, further comprising:
an attachment point coupled to the back surface of the patch applicator band, the attachment point comprising a first hook and pile material.

9. The apparatus of claim 8, further comprising:
a patch having an outer surface carrying one or more identifying indicia; and
an inner surface comprising a cooperating second hook and pile material for removable attachment of the patch to the attachment point.

10. The apparatus of claim 9, wherein a length of the elongate strap corresponds to a length of the wristband.

11. The apparatus of claim 10, wherein a width of the elongate strap is about twice a width of the wristband.
